(19) United States
(12) Patent Application Publication
(10) Pub. No.: US 2013/0315382 A1
(43) Pub. Date: Nov. 28, 2013

(54) SYSTEM AND METHOD FOR ROBUST CALL CENTER OPERATION USING MULTIPLE DATA CENTERS

(71) Applicants: Hadas LIBERMAN, Kadima, IL (US); Yuval Marco, Netanya (IL); Igor Cher, Rehovot (IL); Ziv Grinberg, Netanya (IL); Linat Polak Mart, Hod-Hashron (IL); Efim Kolodizner, Ashdod (IL); Roni Krivoshey, Ramat Hashron (IL); Leon Portman, Rishon LeZion (IL); Shay Levy, Ra'anana (IL); Asaf Kutner, Ganey Tikva (IL); Sharon Shelly, Petach Tikva (IL); Yaniv Bar, Eilat (IL)

(72) Inventors: Hadas LIBERMAN, Kadima, IL (US); Yuval Marco, Netanya (IL); Igor Cher, Rehovot (IL); Ziv Grinberg, Netanya (IL); Linat Polak Mart, Hod-Hashron (IL); Efim Kolodizner, Ashdod (IL); Roni Krivoshey, Ramat Hashron (IL); Leon Portman, Rishon LeZion (IL); Shay Levy, Ra'anana (IL); Asaf Kutner, Ganey Tikva (IL); Sharon Shelly, Petach Tikva (IL); Yaniv Bar, Eilat (IL)

(73) Assignee: Nice Systems Ltd., Ra'anana (IL)

(21) Appl. No.: 13/479,292

(22) Filed: May 24, 2012

(51) Int. Cl. G06F 11/20; H04M 3/08

(52) U.S. Cl. 379/1.02; 714/4.11; 714/E11.073

(57) ABSTRACT

A method of providing robust call center operation for an organization, based on a first data center with computerized components that provide service to the call center, including, receiving at a failover manager having a processor and memory, notification from a user to shut down components of the first data center providing service to the call center, shutting down or verifying non-functionality of the components of the first data center providing service to the call center, activating similar components from a second data center to replace functionality of the first data center, wherein the components of the first data center and the second data center are connected over a network, and updating references of the call center to access the components from the second data center instead of the components from the first data center.

### FIELD OF THE INVENTION

The present invention relates generally to call center operation and more specifically to preventing service failure using multiple data centers to support the call centers.

### BACKGROUND OF THE INVENTION

Many organizations use call centers to communicate with their clients. The call center may include multiple agents located at one or more geographical locations connected together to form a virtual call center. The call centers are supported by an organizational data center which includes computers and network equipment to route and handle the calls. Conversations with call centers representatives may be recorded to a database at the data center so that the content of the call sessions can be retrieved at a later date for review or analyzed for various reasons such as for example to verify the quality of service provided by the agents.

An organization with offices located at multiple geographical locations may maintain multiple data centers, for example one for each location. Each data center includes its own database, call logging components, and application server to support the agents connected to the data center. By reducing the number of data centers and combining call centers to function from fewer data centers the organization can reduce costs. On the other band by maintaining multiple data centers the organization can reduce service downtime in case of failure or problems at one of the locations.

Telephone system vendors such as Avaya and Cisco offer solutions for organizations with multiple data centers. The solutions allow load distribution of calls to multiple data centers. A caller is transparently transferred to one of the call centers based on availability. If one data center is unavailable calls can be transferred to a different data center.

Generally each data center deploys a recording system to record calls and a database to store the recordings. In case of failure in the recording system or database at a specific data center, new calls arriving at the call center supported by that data center will not be recorded. Instead calls can be handled by the call center without recording the call or transferred to other data centers. If the recording is essential then calls cannot be handled by that data center and the rest of the functional components at the data center will not be used either. If an agent is limited to work only with a specific data center then he/she will remain idle.

If a disaster occurs at a specific data center causing the entire data center to shutdown (e.g. component failure of essential components, power outage or physical shut down due to floods, fire, weather etc.) the other call centers can handle new calls however previous recordings at the failed data center may be unavailable unless they were hacked up to a storage center that is available.

### SUMMARY OF THE INVENTION

An aspect of an embodiment of the invention, relates to a system and method for providing robust operation of an organizational call center. The call center is supported by a multi data center including two or more data centers at different geographical locations to support functionality of the call center. Each data center includes computerized components to record the calls and provide application services to be provided by service representatives at the call center. The multi data center also includes a failover manager, which is optionally implemented as an application on a general purpose computer. The failover manager is provided to receive notification from an administrator or user in charge of the call center to shut down one of the data centers and have its functionality replaced by another data center. In some embodiments of the disclosure, the data centers may include multiple hubs wherein each hub provides full functionality for the call center. Optionally, the failover manager can transfer functionality of a single hub to another hub at a different data center, or transfer functionality of an entire data center to a different data center.

The transfer of functionality is essentially transparent to the clients using the call center and transparent to service agents except for failures in the middle of a conversation.

In some embodiments of the disclosure, the second data center may be held in standby mode, for example only to be activated when needed to replace a failed data center or failed component. Alternatively, the first data center, second data center and any other data center may all be active and functional and may be used during standard operation to distribute the load, handling callers and recording conversations.

There is thus provided according to an exemplary embodiment of the disclosure a method of providing robust call center operation for an organization, based on a first data center with computerized components that provide service to the call center, including:

Receiving at a failover manager having a processor and memory, notification from a user to shut down components of the first data center providing service to the call center;

Shutting down or verifying non-functionality of the components of the first data center providing service to the call center;

Activating similar components from a second data center to replace functionality of the first data center; wherein the components of the first data center and the second data center are connected over a network; and

Updating references of the call center to access the components from the second data center instead of the components from the first data center.

In an exemplary embodiment of the disclosure, the components of the second data center are in a standby mode in which the components do not initially provide service to the call center unless activated by the failover manager. Alternatively, the components of the second data center are in an active mode in which the second data center provides service to the call center together with the first data center. Optionally, the failover manager is located at a different location than the first data center. In an exemplary embodiment of the disclosure, the failover manager is located at a different location than all data centers. Optionally, the data centers include an interaction center component that controls recordation of the content of calls and meta-data related to the calls to a database or storage center.

In an exemplary embodiment of the disclosure, the data centers include one or more capture units which record audio data to a storage center. Optionally, the data centers include a database for storing meta-data related to the calls handled by the call center. In an exemplary embodiment of the disclosure, the data centers include an application server that is accessible by service representatives to provide services to callers. Optionally, the first data center includes the same components controlled by the failover manager as the second data center. In an exemplary embodiment of the disclosure, the first data center includes multiple data hubs each data hub including components to provide independent functionality to the call center. Optionally, the second data center includes multiple data hubs to serve as replacements for the data hubs of the first data center. In an exemplary embodiment of the disclosure, the failover manager transfers functionality of a single hub from the first data center to the second data center shutting down the first data hub at the first data center and without interfering with the functionality of other data hubs at the first data center. Optionally, the failover manager transfers functionality of all data hubs from the first data center to the second data center and shuts down functionality of all the data hubs at the first data center.

There is further provided according to an exemplary embodiment of the disclosure a non transitory computer storage medium, including a computer application for providing robust call center operation according to the above method.

There is further provided according to an exemplary embodiment of the disclosure a failover manager for providing robust call center operation for an organization, based on a first data center with computerized components that provides service to the call center, including:

A computing platform with a processor and memory to execute a failover application, the application comprising:

An execution manager to receive notification from a user to shut down components at the first data center and to activate similar components at a second data center for replacing functionality of components of the first data center to serve as a call center; wherein the components at the first data center and second data center are connected over a network; the execution manager further updates references of the call center to access the replacement components instead of the failed components.

In an exemplary embodiment of the disclosure, the failover manager includes:

a user interface including a main window and a configuration wizard; wherein the main window presents the status of the data centers; and wherein the configuration wizard maps components of the first data center and additional data centers and configures which components will be shut down and which components will be activated.

Optionally, the failover manager includes a configuration manager that records configuration information and access information of components monitored by the failover manager to enable access to the components and be able to instruct them to be activated or shut down,

There is further provided according to an exemplary embodiment of the disclosure a multi data center providing robust call center services for an organization, including:

A first data center with computerized components for providing service to a call center;

A second data center with computerized components for providing service to a call center;

A failover manager on a computerized platform having a processor and memory for providing robust call center services using the first data center and the second data center;

Wherein the failover manager receives notification from a user to transfer functionality from a first data center to a second data center;

Wherein the failover manager shuts down or verifies non-functionality of components of the first data center and activates components from the second data center to replace functionality of the first data center;

Wherein the components of the first and second data center are connected over a network and the failover manager updates references of the call center to access the second data center instead of the first data center.

### BRIEF DESCRIPTION OF THE DRAWINGS

The present invention will be understood and better appreciated from the following detailed description taken in conjunction with the drawings. Identical structures, elements or parts, which appear in more than one figure, are generally labeled with the same or similar number in all the figures in which they appear, wherein:

FIG. 1 is a schematic illustration of a multi data center system, according to an exemplary embodiment of the disclosure;

FIG. 2 is a flow diagram of handling a failover process by a failover manager, according to an exemplary embodiment of the disclosure;

FIGS. 3A, 3B and 3C are schematic illustrations of 3 states of interaction centers in a multi data center, according to an exemplary embodiment of the disclosure;

FIGS. 4A, 4B and 4C are schematic illustrations of 3 states of databases in a multi data center, according to an exemplary embodiment of the disclosure;

FIGS. 5A, 5B and 5C are schematic illustrations of 3 states of application servers in a multi data center, according to an exemplary embodiment of the disclosure;

FIG. 6 is a schematic illustration of the components of a failover manager, according to an exemplary embodiment of the disclosure;

FIGS. 7A, 7B, 7C and 7D are schematic illustrations of a multi data center with multiple hubs, according to an exemplary embodiment of the disclosure;

FIGS. 8A, 8B, 8C, 8D and 8E are schematic illustrations of a multi data center with multiple hubs in a crossed link configuration, according to an exemplary embodiment of the disclosure; and

FIGS. 9A and 9B are schematic illustrations of a multi data center with multiple hubs in other configurations, according to an exemplary embodiment of the disclosure.

### DETAILED DESCRIPTION

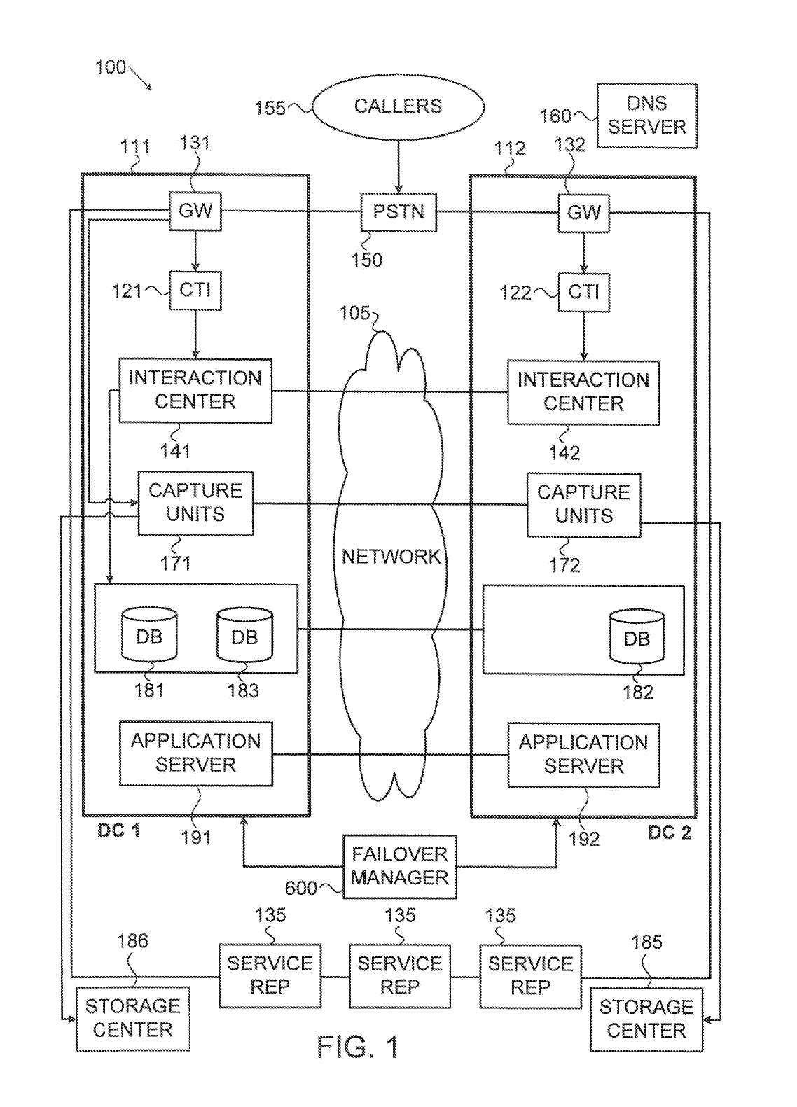

FIG. 1 is a schematic illustration of a multi data center 100, according to an exemplary embodiment of the disclosure. Multi data center 100 includes at least two data centers (DC1-111 and DC2-112) and a failover manager 600 to achieve robust call center operation.

In an exemplary embodiment of the disclosure, an organization establishes a first data center (DC1) 111 to provide call center services. Callers 155 can contact data center 111 using standard telephones or using VoIP telephones through public switched telephone networks (PSTN) 150 or via the Internet. Optionally, data center 111 includes a switch or gateway 131 to route calls to a service representative 135. In an exemplary embodiment of the disclosure gateway 131, routes a copy of the audio packets of the call to a capturing unit 171 based on instructions from an interaction center (IC) 141. Alternatively the audio packets are forwarded from the service representative to a capturing unit 171. The calls are handled by a computer telephony integration server (CTI) 121 that extracts the call details (meta-data) about incoming and outgoing calls (e.g. caller telephone number, call time, call duration, name of caller, location of caller, the telephone number dialed and other information) and provides it to interaction center 141.

In an exemplary embodiment of the disclosure, interaction center 141 receives the meta-data from the computer telephony integration server 121 to facilitate recordation of the content of the calls and their related meta-data. The gateway 131 transfers the audio content of the call to capturing unit 171 according to instructions from interaction center 141. Capturing unit 171 stores the captured audio locally and then transfers it for permanent storage at a storage center 185 (or 186). In an exemplary embodiment of the disclosure, the interaction center 141 provides the meta-data of the call to a local data base 181 for future manipulation. The storage center 185 (or 186) may be a local data base or a remote storage service provided by data storage companies.

In an exemplary embodiment of the disclosure, database 181 may apply a protection scheme to prevent data loss, for example using two or more physical hard disks, and/or implementing a disk mirroring scheme or other data replication scheme (e.g. SRDF).

In an exemplary embodiment of the disclosure, data center 111 includes an application server 191 that extracts information from the local database 181 and/or storage center 185 (or 186) and provides information to service representatives 135 and/or external clients that are authorized to view the data. Optionally, application server 191 enables the service representatives 135 to respond to customer inquiries and update customer details. In an exemplary embodiment of the disclosure, application server 191 may also allow extracting recorded conversations and data related to the conversations from storage center 185 (or 186).

In an exemplary embodiment of the disclosure, multi data center 100 includes at least two data centers (DC1 111 and DC2 112) with similar components: for example each having a gateway (131, 132), a computer telephony integration server (121, 122), an interaction center (141, 142), capture units (171, 172), a database (181, 182) and an application server (191,192)

It should be noted that the data centers are not necessarily symmetrical. Some data centers may, include more units than others or additional components to provide additional functions other than those described above. Optionally, some data centers may include redundant components (e.g. multiple call capture units, multiple disk drives) to allow continuous operation of the data center in case of failure of a component.

In an exemplary embodiment of the disclosure, the data centers (111, 112) are connected together over a network 105 (e.g. a LAN or WAN) to allow a respective component from another data center (111, 112) to be used to replace or supplement the function of a failed component. In an exemplary embodiment of the disclosure, failover manager 600 controls, activation and deactivation of components in the data centers (DC1 111, DC2 112) at multi data center 100 to achieve robust operation of the system.

In some embodiments of the disclosure one data center 111 is active and the second data center 112 is placed in standby mode. This state is referred to as active-standby mode. The standby data center 112 is provided to serve as a backup in case of failure of a component or a disaster wherein the entire data center is shut down. Alternatively, both data centers (111 and 112) may be active. This state is referred to as active-active mode, wherein both data centers 111, 112 simultaneously serve to handle callers and allow balance of the load between the data centers.

In case of component failure at a data center, when one or more components at an active data center fail, the data center may have multiple components of the type that failed and continue to function with less components of that type, for example data center 111 may have multiple capture units 171 and continue to function with less active units. Alternatively or additionally, the data center may have backup units which are activated to replace a failed component. Further alternatively, components from one data center may be used to replace functionality of a failed component at another data center. Optionally, in the case of component failure the replacement process may be automatic or responsive to a command from an administrator.

In an exemplary embodiment of the disclosure, if many components fail or if there are problems preventing normal operation of a data center, for example lack of compatible replacement components, an administrator may instruct failover manager 600 to transfer control to a different active data center or standby data center. Optionally, failover manager 600 may be implemented as an application on a general purpose computer with a processor and memory or may be implemented as a dedicated hardware element. Optionally, failover manager 600 will be located external to data center 111 and even external to data center 112 especially if both are active; to prevent malfunction of failover manager 600 if an entire site fails. In an exemplary embodiment of the disclosure, failover manager 600 is designed to replace the entire data center by a single command from an administrator.

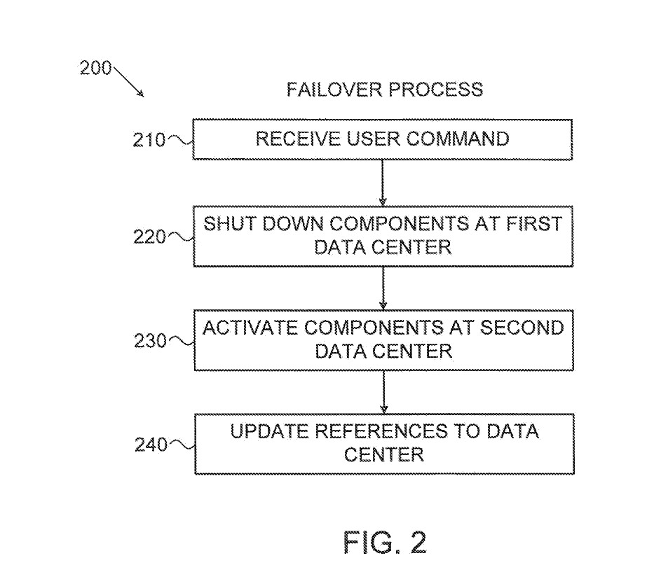

FIG. 2 is a flow diagram 200 of handling a failover process by failover manager 600, according to an exemplary embodiment of the disclosure. In an exemplary embodiment of the disclosure failover manager 600 receives notification from a site administrator to shut down a data center (210). In an exemplary embodiment of the invention, upon receiving notification failover manager 600 shuts down (220) components of the first data center that is being shut down, for example if transferring control to data center 112 from data center 111 all of the components of data center 111 are shut down whether they are functional or not. Failover manager then activates (230) the components of the second data center if they were in standby mode. In an exemplary embodiment of the disclosure, failover manager 600 will execute scripts to update elements that reference the components of the data centers to reference the functional data center instead of the non-functional data center (240), for example by updating a DNS server 160 to reference data center 112 instead of data center 111. In some embodiments of the disclosure, clients that reference the data centers (111, 112) are initially programmed with two DNS IP's (e.g. primary and secondary) so that they can automatically access either of two data centers, whichever functions.

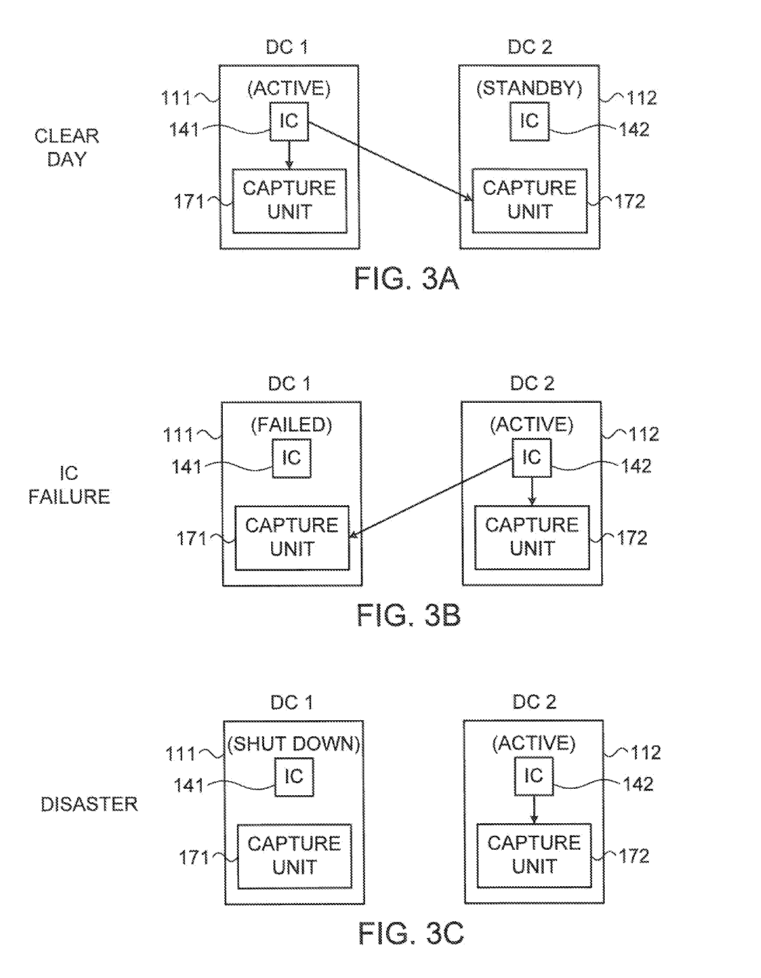

FIGS. 3A, 3B and 3C are schematic illustrations of 3 states of interaction centers (141, 142) in multi data center 100, according to an exemplary embodiment of the disclosure. FIG. 3A shows the status on a clear day when all components of multi data center 100 are functional, interaction center 141 at data center 111 is active and interaction center 142 at data center 112 is in standby mode (active-standby mode). Optionally, capture unit 171 of active data center 111 will be used to record calls accepted by interaction center 141 at data center 111. In some embodiments of the disclosure also capture unit 172 of data center 112 may also be used to record calls accepted by interaction center 141 at data center 111 instead of or in addition to capture unit 171 even though data center 112 is in standby mode. FIG. 3B shows the status if interaction center 141 at data center 111 fails. Optionally, interaction center 142 at data center 112 will be automatically activated to control and capture calls instead of interaction center 141. Interaction center 142 may also write the metadata of the calls to database 181 at data center 111 instead of database 182 at data center 112. FIG. 3C shows a third case wherein a disaster occurs and the entire data center 111 is shut down. In such a case, the administrator will instruct failover manager 600 to shut down data center 111 and more all activity to data center 112. Accordingly, interaction center 142 at data center 112 will function alone with its local capture unit 172 until data center 111 can be reactivated.

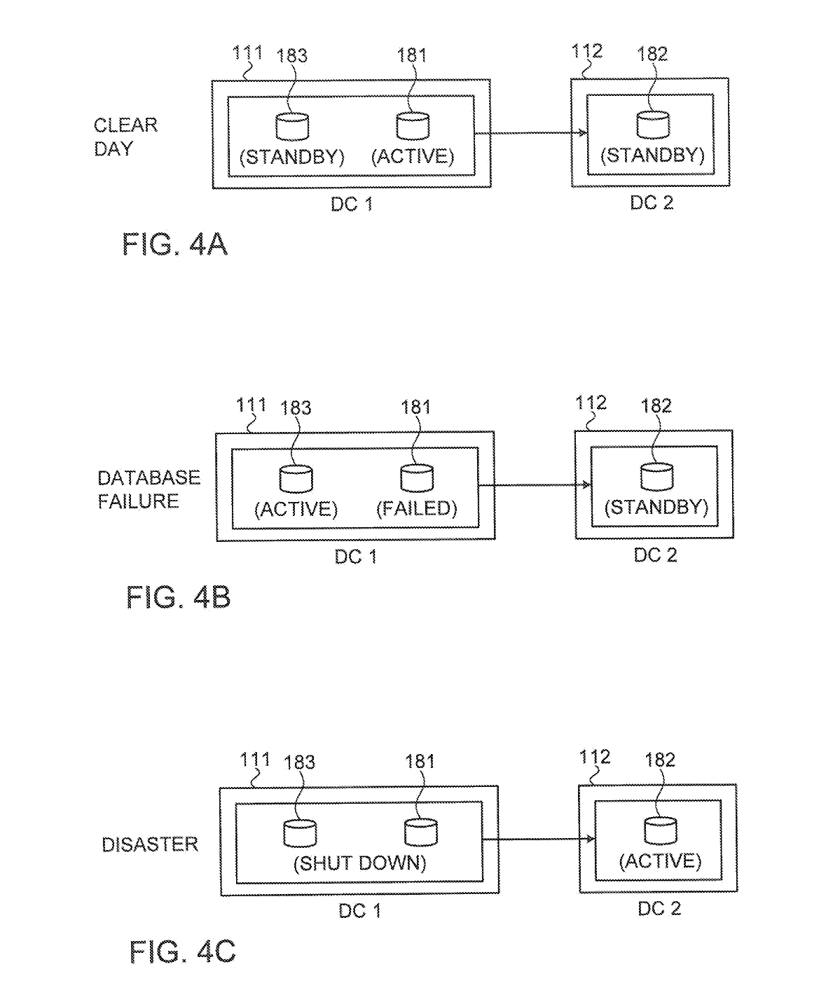

FIGS. 4A, 4B and 4C are schematic illustrations of 3 states of databases 181, 182 at multi data center 100, according to an exemplary embodiment of the disclosure. FIG. 4A shows the status on a clear day when all components of multi data center 100 are functional, database 181 at data center 111 is active and database 182 at data center 112 is in standby mode (active-standby mode). In some embodiments of the disclosure, data center 111 includes a backup database 183 which is initially in standby mode. Optionally, database 182 is replicated or updated from database 181 even when data center 112 is in standby mode, so that in case of failure of data center 111, database 182 can step in and replace database 181. In some embodiments of the disclosure database 182 is updated periodically, for example every minute or every hour. Alternatively, database 182 may be updated every time a transaction is completed or based on some other action.

In an exemplary embodiment of the disclosure, in case of database failure in active database 181 (as shown in FIG. 4B), backup database 183 will take over and serve as the active database to prevent failure of data center 111. Optionally, in active-active mode database 181 at data center 111 and database 182 at data center 112 may serve as real time backups for each other. In an exemplary embodiment of the disclosure, in case of disaster at data center 111 (FIG. 4C) wherein the entire data center 111 is shut down, database 182 at data center 112 will serve by itself as the active database and will be backed up/replicated to database 181 or database 183 at data center 111 if possible (e.g. if database 181 or database 183 at datacenter 111 is functional) or when the failure at data center 111 is overcome.

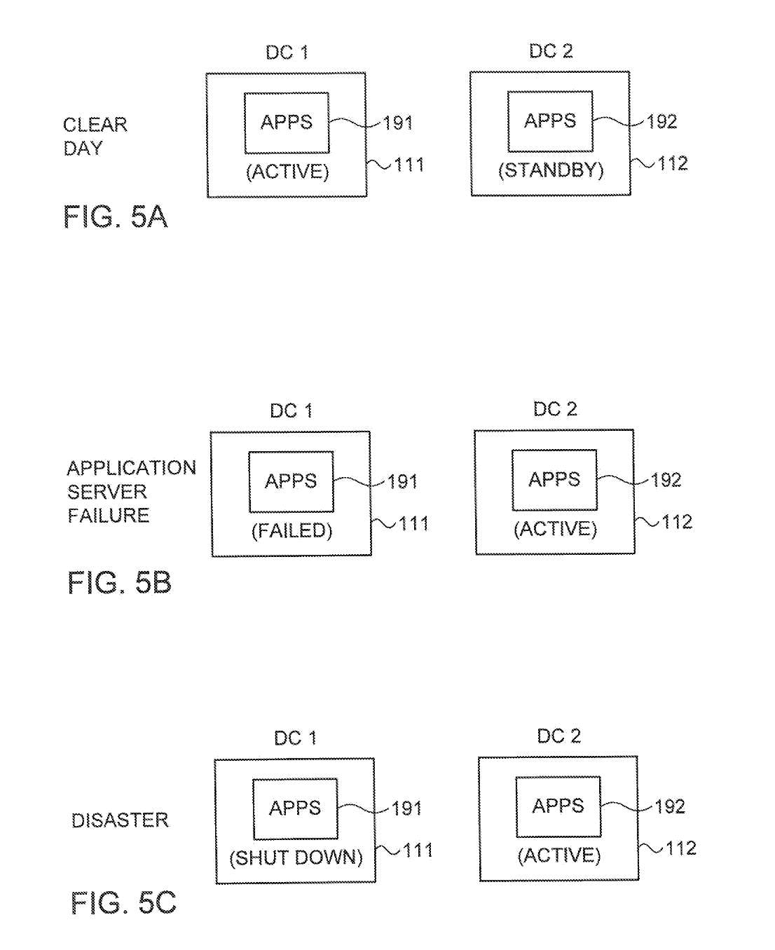

FIGS. 5A, 5B and 5C are schematic illustrations of 3 states of application servers 191, 192 at multi data center 100, according to an exemplary embodiment of the disclosure. FIG. 5A shows the status on a clear day when all components of multi data center 100 are functional, application server 191 at data center 111 is active and application server 192 at data center 112 is in standby mode (active-standby mode). In an exemplary embodiment of the disclosure, application server 191 at data center 111 provides data services to service representatives 135, for example updating user information or recording purchase orders responsive to conversations with users. Optionally, application server 191 uses database 181 to extract and store user information and call information. Additionally, the service representatives 135 may access storage center 185 (or 186) to retrieve recorded calls. In an exemplary embodiment of the disclosure, if application server 191 fails (FIG. 5B), application server 192 will take over to provide the services instead of application server 191. Optionally, application server 192 may access database 181 to continue with the same data used by application server 191 that failed. Alternatively, database 182 may be updated with the data from database 181 so that application server 192 can use its local database 182 without loss of transaction information.

In an exemplary embodiment of the disclosure, in case of disaster at data center 111 (FIG. 5C) wherein the entire data center 111 is shut down, application server 192 at data center 112 will serve as the active application server together with the components from data center 112. Accordingly, application server 192 is used to provide services to the service representatives 135.

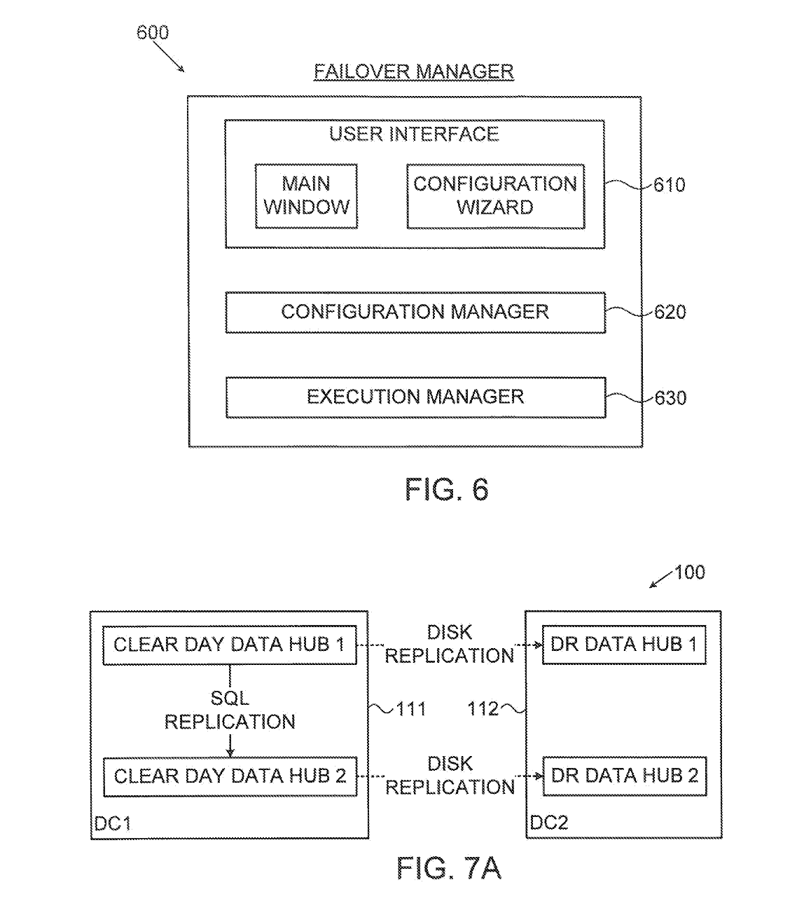

FIG. 6 is a schematic illustration of the components of a failover manager 600, according to an exemplary embodiment of the disclosure. In an exemplary embodiment of the disclosure, failover manager 600 includes three main components: a user interface 610, a configuration manager 620, and an execution manager 630. In an exemplary embodiment of the disclosure, user interface 610 serves as an interface with the user and includes 2 main parts:

1. A main window that presents to the user the current status of the data centers under its control.

2. A configuration wizard to map the components of the data centers and configure how to handle the components when disaster occurs.

Configuration manager 620 is responsible to record configuration information of the components of multi data center 100 and access information so that failover manager 600 may control the components by instructing them to be activated or shut down and with which other components they interact.

Execution manager 630 is responsible to perform activation and deactivation of components and instruct components to interact with each other.

In an exemplary embodiment of the disclosure, if failover manager 600 is instructed to replace a data center the data center is then shut down and the replacement data center is activated in its place.

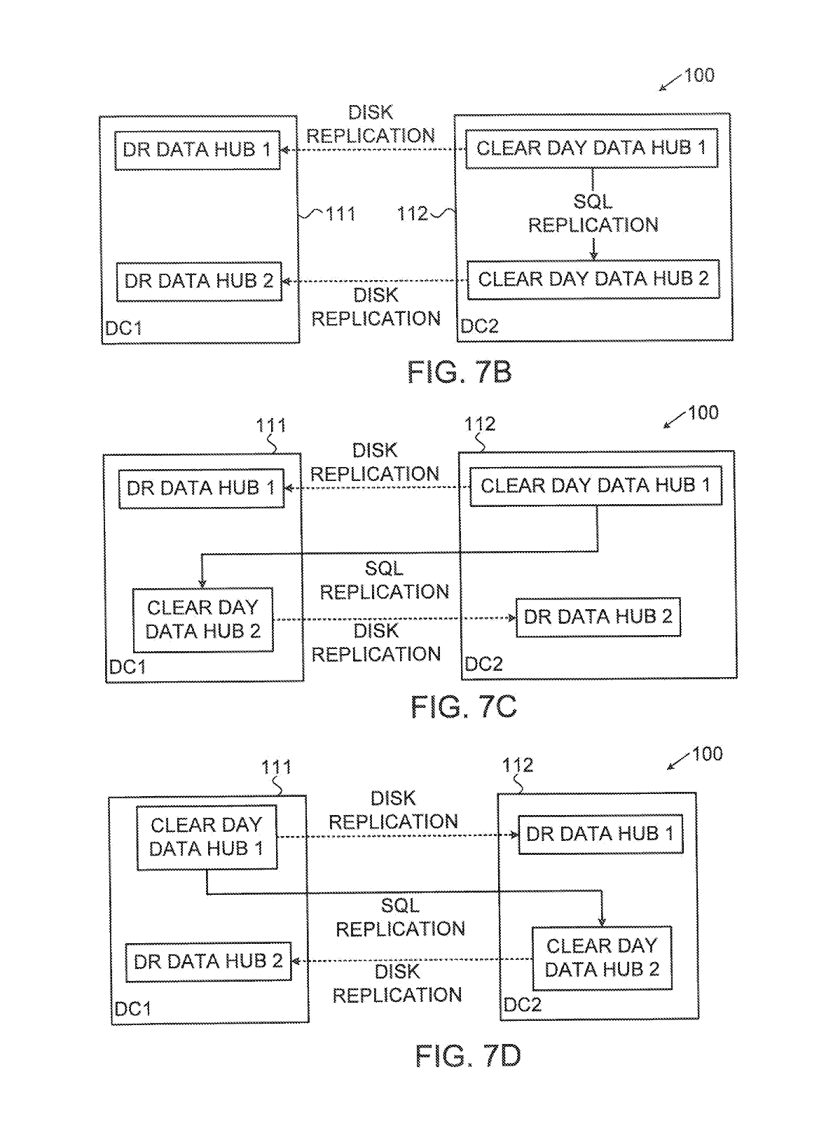

In an exemplary embodiment of the disclosure, each data center (111 and 112) may include two independent functional data centers referred to as data hubs, for example each dealing with a different line of business or to enhance scalability by activating a second hub if necessary. FIGS. 7A, 7B, 7C and 7D are schematic illustrations of a multi data center 100 with multiple hubs, according to an exemplary embodiment of the disclosure. As depicted in FIG. 7A in an exemplary embodiment of the disclosure two data hubs may be functional in a clear day situation at data center 111 (DC1). Optionally, data center 112 (DC2) includes two disaster recovery (DR) data hubs to serve as backups in case of failure at any of the hubs at data center 111. Optionally, during normal use the administrative information (e.g. user configuration) in the database of the first hub (Hub 1) is replicated (e.g. marked as SQL replication in FIG. 7A) to the database of the second hub (Hub 2), thus in case of failure the user configuration information is known to the other hub. In some embodiments of the disclosure, the database of the first hub may be replicated entirely to DR data hub 1 at data center 112, and the database of the second hub may be replicated to DR data hub 2 at data center 112 to prevent data loss.

In case of failure of the entire data center 111, failover manager 600 will replace them with the disaster recovery hubs at data center 112 as shown in FIG. 7B. Optionally, the hubs of the failed data center 111 will serve as the disaster recovery hubs for data center 112, for example after repairing data center 111 or at least if the databases of the failed data center are capable of backing up the active databases.

In some embodiments of the disclosure, both data centers may be active, wherein the hubs of each data center serve as virtual disaster recovery hubs for each other.

In case of failure of a single hub only that hub needs to be replaced by its disaster recovery hub. FIG. 7C shows failover of data hub 1 and FIG. 7D shows failover of data hub 2.

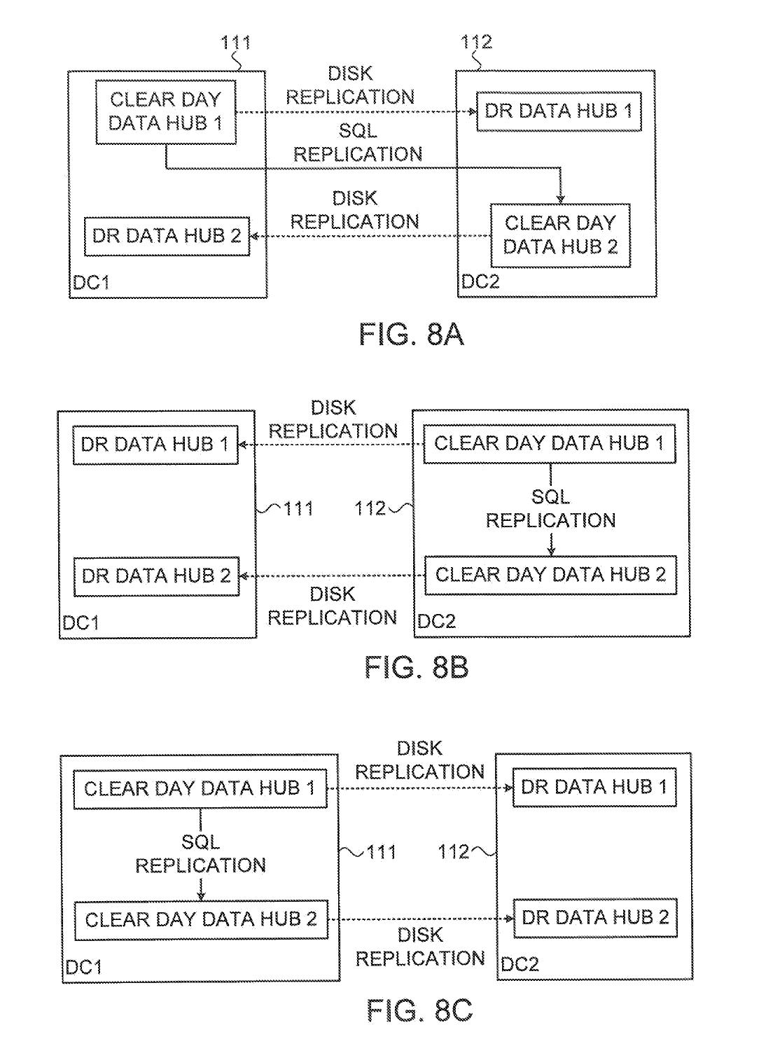

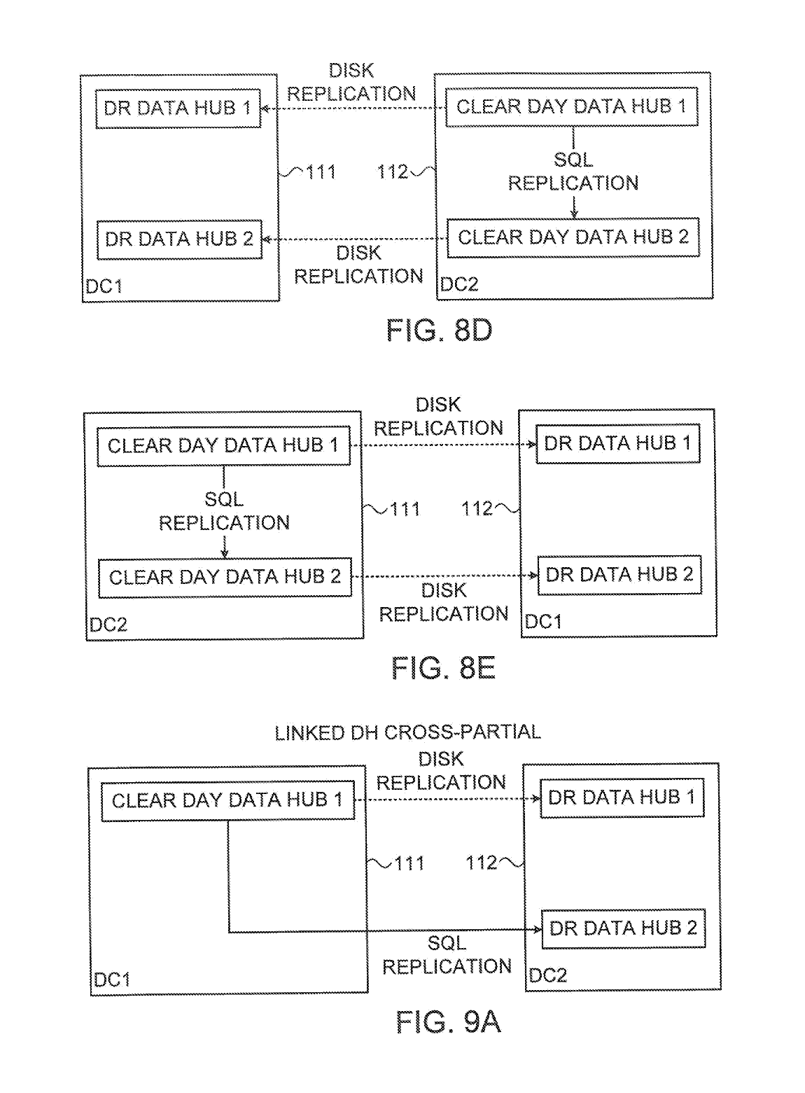

FIGS. 8A, 8B, 8C, 8D and 8E are schematic illustrations of a multi data center with multiple hubs in a crossed link configuration, according to an exemplary embodiment of the disclosure. In a crossed link configuration, data hub 1 at data center 1 is functioning in a clear day status and likewise data hub 2 at data center 2 (FIG. 8A). In an exemplary embodiment of the disclosure, failover manager 600 can perforin one of four different actions according to the administrator's request:

1. Failover the entire data center 1 to data center 2, as shown in FIG. 8B, so that both data hubs at data center 2 will be active and both data hubs at data center 1 will be down, hi this case data hub 2 at data center 2 continues to function as before and is not impact by the failover process;

2. Failover of the entire data center 2 to data center 1, as shown in FIG. 8C, so that both hubs at data center 1 will become active and both data hubs at data center 2 will be down. In this case data hub 1 at data center 1 continues to function as before and is not impact by the failover process;

3. Failover only of data hub 1 at data center 1, as shown in FIG. 8D, so that both hubs at data center 2 will become active and data hub 1 of data center 1 will be down while data hub 2 at data center 1 will remain in standby mode;

4. Failover only of data hub 2 at data center 2, as shown in FIG. 8E, so that both hubs at data center 1 will become active and data hub 2 of data center 2 will be down while data hub 1 at data center 2 will remain in standby mode.

It should be noted that the failover operation may be requested by the administrator for various reasons, for example due to component failure at a data hub or to initiate maintenance of components of a data hub or entire data center.

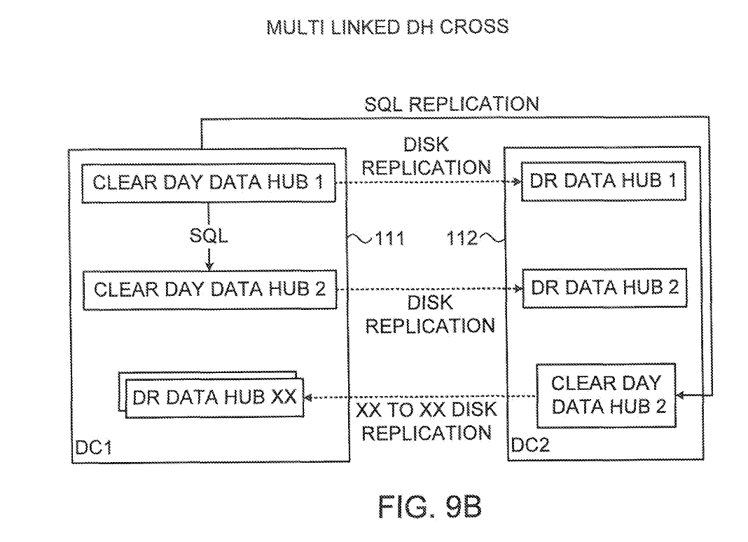

FIGS. 9A and 9B are schematic illustrations of a multi data center with multiple hubs in other configurations, according to an exemplary embodiment of the disclosure. FIG. 9A shows a configuration where data center 1 has a single active data hub and data center 2 has a disaster recovery hub for the data hub of data center 1 and an active data center at data hub 2. Optionally, disaster recovery data hub 1 at data center 2 serves as a backup for the data hub 1 at data center 1 in case of a disaster at data center 2, data hub 1 of data center 1 will need to share functionality with the clients of data hub 2 of data center 2.

FIG. 9B shows a configuration where each data center has multiple hubs. Optionally, some may have dedicated disaster recovery hubs and some may not. Optionally, failover manager 600 may transfer activity of a single hub or an entire data center. During transfer failover manager 600 will shut down activity at the hubs or center that are being shut down and will transfer activity to standby disaster recovery hubs or combine activity with an active hub.

It should be appreciated that the above described methods and apparatus may be varied in many ways, including omitting or adding steps, changing the order of steps and the type of devices used. It should be appreciated that different features may be combined in different ways. In particular, not all the features shown above in a particular embodiment are necessary in every embodiment of the invention. Further combinations of the above features are also considered to be within the scope of some embodiments of the invention.

It will be appreciated by persons skilled in the art that the present invention is not limited to what has been particularly shown and described hereinabove. Rather the scope of the present invention is defined only by the claims, which follow.

1. A method of providing robust call center operation for an organization, based on a first data center with computerized components that provide service to the call center, comprising:
receiving at a failover manager having a processor and memory, notification from a user to shut down components of the first data center providing service to the call center;
shutting down or verifying non-functionality of the components of the first data center providing service to the call center;
activating similar components from a second data center to replace functionality of the first data center; wherein the components of the first data center and the second data center are connected over a network; and
updating references of the call center to access the components from the second data center instead of the components from the first data center.

2. A method according to claim 1, wherein the components of the second data center are in a standby mode in which the components do not initially provide service to the call center unless activated by the failover manager.

3. A method according to claim 1, wherein the components of the second data center are in an active mode in which the second data center provides service to the call center together with the first data center.

4. A method according to claim 1, wherein the failover manager is located at a different location than the first data center.

5. A method according to claim 1, wherein the failover manager is located at a different location than all data centers.

6. A method according to claim 1, wherein the data centers include an interaction center component that controls recordation of the content of calls and meta data related to the calls to a database or storage center.

7. A method according to claim 1, wherein the data centers include one or more capture units which record audio data to a storage center.

8. A method according to claim 1, wherein the data centers include a database for storing meta data related to the calls handled by the call center.

9. A method according to claim 1, wherein the data centers include an application server that is accessible by service representatives to provide services to callers.

10. A method according to claim 1, wherein the first data center includes the same components controlled by the failover manager as the second data center.

11. A method according to claim 1, wherein the first data center includes multiple data hubs each data hub including components to provide independent functionality to the call center.

12. A method according to claim 11, wherein the second data center includes multiple data hubs to serve as replacements for the data hubs of the first data center.

13. A method according to claim 11, wherein the failover manager transfers functionality of a single hub from the first data center to the second data center shutting down the first data hub at the first data center and without interfering with the functionality of other data hubs at the first data center.

14. A method according to claim 11, wherein the failover manager transfers functionality of all data hubs from the first data center to the second data center and shuts down functionality of all the data hubs at the first data center.

15. A non transitory computer storage medium, comprising:
a computer application for providing robust call center operation by executing a method according to claim 1.

16. A failover manager for providing robust call center operation for an organization, based on a first data center with computerized components that provides service to the call center, comprising:
a computing platform with a processor and memory to execute a failover application, the application comprising:
an execution manager to receive notification from a user to shut down components at the first data center and to activate similar components at a second data center for replacing functionality of components of the first data center to serve as a call center; wherein the components at the first data center and second data center are connected over a network; the execution manager further updates references of the call center to access the replacement components instead of the failed components.

17. A failover manager according to claim 16, further comprising:
a user interface including a main window and a configuration wizard; wherein the main window presents the status of the data centers; and wherein the configuration wizard maps components of the first data center and additional data centers and configures which components will be shut down and which components will be activated.

18. A failover manager according to claim 16, further comprising:
configuration manager that records configuration information and access information of components monitored by the failover manager to enable access to the components and be able to instruct them to be activated or shut down.

19. A multi data center providing robust call center services for an organization, comprising:
a first data center with computerized components for providing service to a call center;
a second data center with computerized components for providing service to a call center;
a failover manager on a computerized platform having a processor and memory for providing robust call center services using the first data center and the second data center;
wherein said failover manager receives notification from a user to transfer functionality from a first data center to a second data center;
wherein the failover manager shuts down or verifies non-functionality of components of the first data center and activates components from the second data center to replace functionality of the first data center;
wherein the components of the first and second data center are connected over a network and the failover manager updates references of the call center to access the second data center instead of the first data center.
